(19) United States
(12) Patent Application Publication
(10) Pub. No.: US 2012/0081087 A1
(43) Pub. Date: Apr. 5, 2012

(54) HUB DEVICE CAPABLE OF SUPPLY POWER

(75) Inventor: Cheng Ching-Wei, Keelung (TW)

(73) Assignee: ACTION STAR ENTERPRISE CO., LTD., Sijhih (TW)

(21) Appl. No.: 12/896,973

(22) Filed: Oct. 4, 2010

(51) Int. Cl. G05F 1/10

(52) U.S. Cl. 323/282

(57) ABSTRACT

The present invention relates to a hub device capable of supplying power, which comprises: a power input unit, a Boost/Buck unit, a power output unit, a control unit, a plurality of first electrical connection units, and a second electrical connection unit. By way of the control unit and the plurality of first electrical connection units, the hub device can provide a hub function for a plurality of the USB connectors; moreover, By means of the power input unit, the Boost/Buck unit and the power output unit, the hub device is able to supply the a portable computer with the necessary power thereof. So that, when a user goes out with the portable computer, the specific power supply of the portable computer may not be carried out; thereof, that makes the living of the user more convenient.

### BACKGROUND OF THE INVENTION

1. Technical Field

The present invention relates to a hub device, and more particularly, to a hub device capable of supplying power, which has a hub function for multiple USB connectors and capable of providing a portable computer with the required power thereof.

2. Description of Related Art

In addition to the battery, a portable electronic device is able to obtain the required power from a power supply device. Referring to FIG. 1, a schematic diagram of a conventional power supply device is illustrated, as shown in FIG. 1, a conventional power supply device 1′ includes: a power input unit 11′, a power conversion unit 12′ and a power output unit 13′, wherein the power input unit 11′ is a power capable with a plug and used for connecting to a power outlet (on the wall). The power conversion unit 12′ can convert the voltage supplied by the power outlet to a rated output voltage, for example, converting the voltage of 110V to the rated output voltage of 12V. The power output unit 13′ is used for connecting to a power inlet 21′ of a portable electronic device 2′. Since the power conversion unit 12′ has a certain size volume, so that, it causes inconvenience when a user carries out the power conversion unit.

Moreover, recently, the computer peripheral products continuously to be introduced new, and the volume thereof are getting to be made to thin, light weight and easily to be carried, so that, based on above reason, computer venders provide a USB hub device for allowing the user to simultaneously connect multiple computer peripheral products to a computer. Please refer to FIG. 2, the schematic diagram of a conventional USB hub device is illustrated, as shown in FIG. 2, a conventional USB hub device 3′ includes: a main body 31′, a USB connector 32′ and a power plug 33′, wherein the main body 31′ has a plurality of USB connector 311′ for connecting the computer peripheral products, the USB connector 32′ is able to connect an USB connector 22′ of the portable computer 3′, and the power plug 33′ is used for connecting the power outlet for supplying the USB connector 311′ with a driving voltage.

According to the above mention, it knows that the conventional USB hub device 3′ supplies the driving voltage to the USB connector 311′; however, if the internal circuits of the conventional USB hub device 3′ can be re-designed and made to be a device having the functions of the power input unit 11′, the power conversion unit 12′ and the power output unit 13′, then, the conventional USB hub device 3′ is able to output the rated output voltage for supplying the portable computer 2′ with the required power thereof. Thus, when the user goes out, the user only carries the portable computer and one USB hub without carrying the specific power supply device of the portable computer, and then the living of the user may become more convenient. Accordingly, the computer venders provide a power USB hub device in order to facilitate the using way of the power supply device and the USB hub device for users, please refer to FIG. 3, which illustrates the schematic diagram of using the power USB hub device, as show in FIG. 3, the power USB hub device 4′ includes a main body 41′, and a hub module and a power supply module are installed in the main body 41′, wherein the hub module has a plurality of USB connectors 411′ for connecting the computer periphery products, the hub module further has a USB plug connector 42′ for connecting the computer, and the power supply module has a power output cable for providing the computer with the power.

Although the power USB hub 4′ described above has the functions of the power supply and the hub, the power USB hub 4′ have the shortcomings:

Since the power USB hub 4′ has the hub module and the power supply module, the manufacturing cost of the power USB hub 4′ is high.

Based on the reason of the point 1, the product price of the power USB hub 4′ can not be lowered.

Whatever the hub module or the power supply module is broken, the user must to buy a new power USB hub 4′, so that the functions of the hub and the power supply is capable of being provided, but that is caused burdens to the user.

Accordingly, in view of the abovementioned power USB hub having the drawbacks and the shortcomings, the inventor of the present application has made great efforts to make inventive research thereon and eventually provided a hub device capable of supplying power.

### BRIEF SUMMARY OF THE INVENTION

The primary objective of the present invention is to provide a hub device capable of supplying power, in which a hub function for multiple USB connectors is provided and the required power for a portable computer is also supplied, thus, when a user carries out the portable computer, the specific power supply device of the portable computer may not need to be taken along, so that the living of the user becomes more and more convenient.

The another objective of the present invention is to provide a hub device capable of supplying power, in which a hub function for multiple USB connectors is provided and the necessary power for a portable computer is also supplied, moreover, the function of adjusting the output power voltage is also provided, so that, it can provide a variety of rated output voltages to all kinds of the portable computer.

Accordingly, to achieve the abovementioned primary objective, the inventor proposes a hub device capable of supplying power, the hub device comprises: a power input unit, a Boost/Buck unit, a power output unit, a control unit, a plurality of first electrical connection units, and a second electrical connection unit.

The power input unit connects to an external power source for receiving an input power, the Boost/Buck unit connects to the power input unit so as to increase/reduce the voltage of the input power, the power output unit connects to the Boost/Buck unit and outputting a rated output voltage, the control unit connects to the Boost/Buck unit, and the plurality of first electrical connection units connect to the control unit, wherein after an electronic device is connected to one of the first electrical connection units, the control unit outputs a driving voltage to drive the first electrical connection unit. The second electrical connection unit connects to the control unit and is used for connecting an external computer.

Moreover, to achieve the another objective, the inventor proposes a hub device capable of supplying power, the hub device comprises: a power input unit, a Boost/Buck unit, a power output unit, a control unit, a plurality of first electrical connection units, a second electrical connection unit, and a voltage adjusting unit.

The power input unit connects to an external power source for receiving an input power, the Boost/Buck unit connects to the power input unit so as to increase/reduce the voltage of the input power, the power output unit connects to the Boost/Buck unit and outputting a rated output voltage, the control unit connects to the Boost/Buck unit, and the plurality of first electrical connection units connect to the control unit, wherein after an electronic device is connected to one of the first electrical connection units, the control unit outputs a driving voltage to drive the first electrical connection unit. The second electrical connection unit connects to the control unit and is used for connecting an external computer. The voltage adjusting unit connects to the Boost/Buck unit, wherein a set voltage value is defined through the voltage adjusting unit, and then the value of the rated output voltage outputted by the power output unit is the same to the set voltage value.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic diagram of a conventional power supply device;

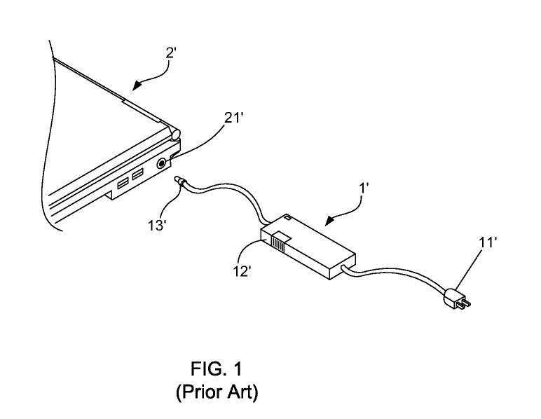

FIG. 2 is the schematic diagram of a conventional USB hub device;

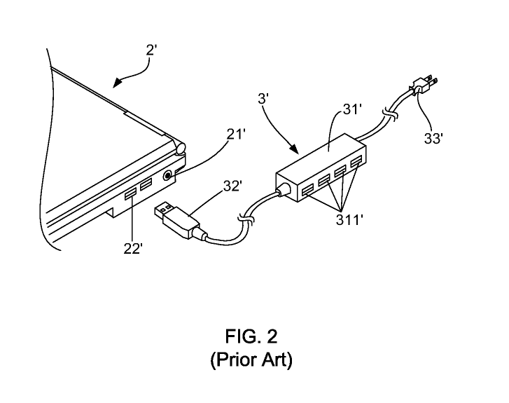

FIG. 3 is the schematic diagram of using a power USB hub device;

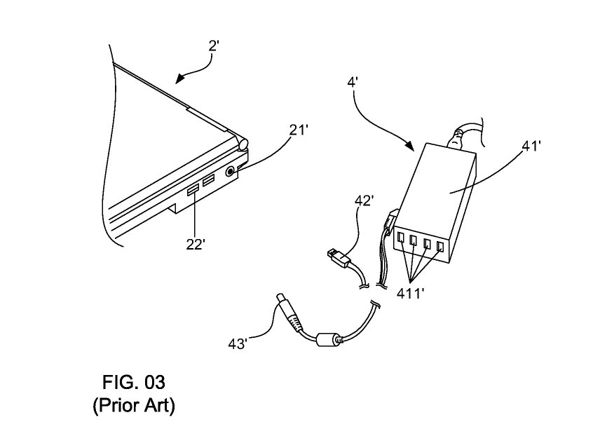

FIG. 4 is a framework view of a hub device capable of supplying power according to the present invention;

FIG. 5 is a first schematic stereo view of the hub device capable of supplying power according to the present invention;

FIG. 6 is a second schematic stereo view of the hub device capable of supplying power according to the present invention;

FIG. 7 is a second framework view of the hub device capable of supplying power according to the present invention; and

FIG. 8 is a third schematic stereo view of the hub device capable of supplying power according to the present invention.

### DETAILED DESCRIPTION OF THE INVENTION

To more clearly describe a hub device capable of supplying power according to the present invention, embodiments of the present invention will be described in detail with reference to the attached drawings hereinafter.

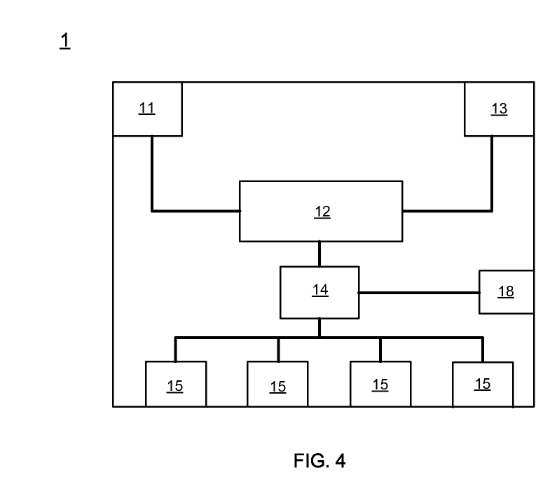

Referring to FIG. 4, a framework view of a hub device capable of supplying power according to the present invention is illustrated, as shown in FIG. 4, the hub device 1 capable of supplying power includes: a power input unit 11, a Boost/Buck unit 12, a power output unit 13, a control unit 14, a plurality of first electrical connection units 15, and a second electrical connection unit 18.

The power input unit 11 connects to an external power source for receiving an input power, the Boost/Buck unit 12 connects to the power input unit 11 so as to increase/reduce the voltage of the input power, the power output unit 13 connects to the Boost/Buck unit 12 and outputting a rated output voltage, the control unit 14 connects to the Boost/Buck unit 12, and the plurality of first electrical connection units 15 connect to the control unit 14, wherein after an electronic device is connected to one of the first electrical connection units 15, the control unit 14 outputs a driving voltage to drive the first electrical connection unit 15. In addition, the second electrical connection unit 18 also connects to the control unit 14 and used for connecting a portable computer.

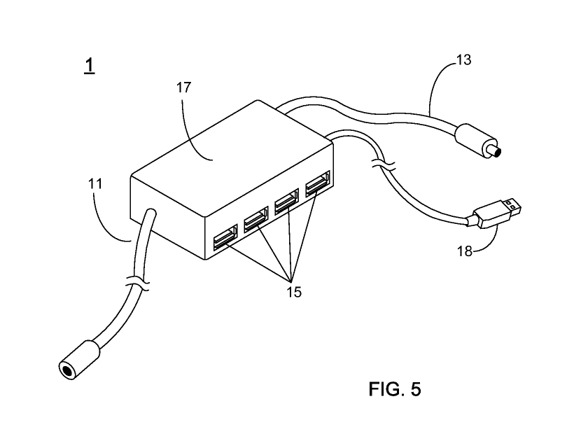

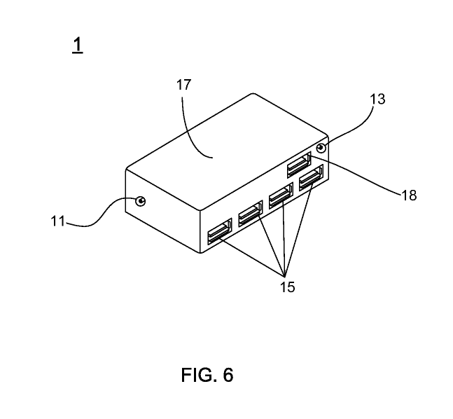

Referring to FIGS. 5 and 6 together, a first schematic stereo view and a second schematic stereo view of the hub device capable of supplying power according to the present invention are illustrated, as shown in FIGS. 5 and 6, the power input unit 11, the Boost/Buck unit 12, the power output unit 13, the control unit 14, the first electrical connection units 15, and the second electrical connection unit 18 can be disposed on a printed circuit board (PCB), and then the PCB and all units on the PCB are covered by a housing 17, so that the framework of the hub device 1 capable of supplying power is specific performed. As shown in FIG. 5, the power input unit 11 and the power output unit 13 are two power cables, respectively, wherein an adapter plug is able to be inserted into the power input unit 11 (power cable), and then the power input unit 11 obtains the input power by way of plugging the adapter plug into a power outlet (on the wall). The design of the power input unit 11 is to ensure that the power input unit 11 can electrically connect with various types of the adapter plug of a power supply device of the portable computer. The power output unit 13 (power cable) can be inserted into a power inlet of the portable computer for supplying the portable computer with the power, thus, the portable computer is able to get the needed power thereof.

Also, as shown in FIG. 6, the power input unit 11 can be the power inlet and the power output unit 13 can be the power outlet, such that, for a user, it is easily to store the cable lines used for connecting to the power inlet and the power outlet. Besides, as shown in FIGS. 5 and 6, the first electrical connection unit 15 is an USB connector, and the type of the USB connector can be USB 2.0 or USB 3.0 in the framework of the hub device 1 according to the present invention. Besides, in FIG. 5, the second electrical connection unit 18 is an USB connection cable, and corresponding to the first electrical connection unit 15, the type of the USB connection cable (the second electrical connection unit 18) can be USB 2.0 or USB 3.0. Moreover, in the FIG. 6, the second electrical connection unit 18 is the USB connector; similarly, the type of the USB connector can be USB 2.0 or USB 3.0 corresponding to the first electrical connection unit 15.

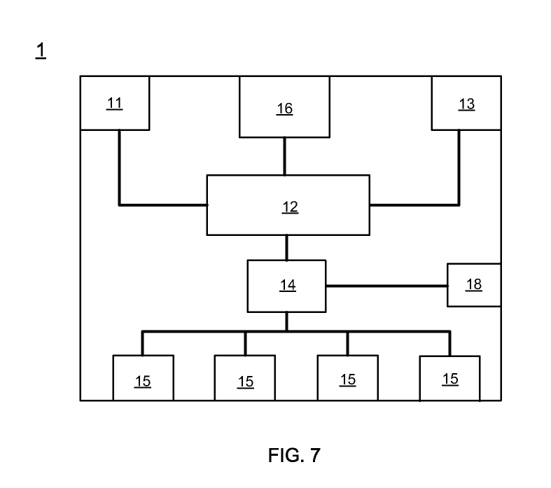

Furthermore, for making the hub device 1 capable of supplying power according to the present invention having more functionality, a second framework of the hub device 1 capable of supplying power is provided. Please refer to FIG. 7, which illustrated a second framework view of the hub device capable of supplying power according to the present invention, as shown in FIG. 7, the second framework of the hub device 1 includes: a power input unit 11, a Boost/Buck unit 12, a power output unit 13, a control unit 14, the plurality of first electrical connection units 15, the electrical connection unit 18, and a voltage adjusting unit 16, wherein the power input unit 11, the Boost/Buck unit 12, the power output unit 13, the control unit 14, the first electrical connection units 15, and the electrical connection unit 18 in the second framework are the same to the units in the first framework described above; thereof, the connections and the functions of the power input unit 11, the Boost/Buck unit 12, the power output unit 13, the control unit 14, the first electrical connection units 15, and the electrical connection unit 18 are not to be repeated. In the second framework of the hub device 1, the voltage adjusting unit 16 connects to the Boost/Buck unit 12, wherein a set voltage value can be defined through the voltage adjusting unit 16, and then the value of the rated output voltage outputted by the power output unit 13 is the same to the set voltage value.

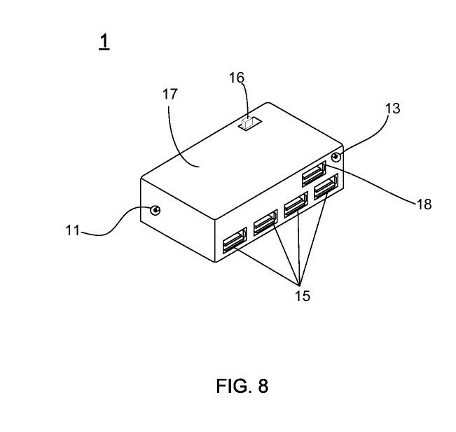

Referring to FIG. 8, which illustrated a third schematic stereo view of the hub device capable of supplying power according to the present invention, as shown in FIG. 8, the power input unit 11, the Boost/Buck unit 12, the power output unit 13, the control unit 14, the first electrical connection units 15, the second electrical connection unit 18, and the voltage adjusting unit 16 can be disposed on the printed circuit board (PCB), and then the PCB and all units on the PCB are covered by a housing 17, such that the second framework of the hub device 1 capable of supplying power is performed. Moreover, as shown in FIG. 8, the voltage adjusting unit 16 is a Multi-step switch capable of being set a variety of the rated output voltage, such as 12V, 15V, 16V, 18V, 19V, 21V, 24V; in addition, the voltage adjusting unit 16 can also be a knob switch. So that, rated output voltage outputted by the power output unit may support the requested voltage of all kinds of the portable computer.

Thus, the hub device capable of supplying power according to the present invention has been disclosed completely and clearly in the above description. In summary, the present invention has the following advantages:
1. The hub device not only provides the hub function for the USB connectors, but also supplies the portable computer with the necessary power; moreover, the hub device can further provide electric power to the power supply of the portable computer.
2. Inheriting from the above-mentioned point 1, since the hub device does not have the power supply module, the product price of the hub device is therefore reduced.
3. When the internal circuits of the hub device are broken, users can spend the price of the general hub to get a new hub device according to the present invention.
4. The hub device according to the present invention further comprises a function of adjusting the output voltage, so as to provide a variety of rated output voltages to all kinds of the portable computer, for driving the portable computer.

The above description is made on embodiments of the present invention. However, the embodiments are not intended to limit scope of the present invention, and all equivalent implementations or alterations within the spirit of the present invention still fall within the scope of the present invention.

I claim:

1. A hub device capable of supplying power, comprising:
a power input unit, connecting to an external power source for receiving an input power;
a Boost/Buck unit, connecting to the power input unit so as to increase/reduce the voltage of the input power;
a power output unit, connecting to the Boost/Buck unit and outputting a rated output voltage;
a control unit, connecting to the Boost/Buck unit;
a plurality of first electrical connection units, connecting to the control unit, wherein after an electronic device is connected to one of the first electrical connection units, the control unit outputting a driving voltage to the first electrical connection unit for driving the first electrical connection unit; and
a second electrical connection unit, connecting to the control unit and being used for connecting an external computer.

2. The hub device capable of supplying power of claim 1, further comprising a voltage adjusting unit, connecting to the Boost/Buck unit, wherein a set voltage value is defined through the voltage adjusting unit, and then the value of the rated output voltage outputted by the power output unit is the same to the set voltage value.

3. The hub device capable of supplying power of claim 1, wherein the power input unit is selected from the group consisting of: a power inlet and a power cable.

4. The hub device capable of supplying power of claim 1, wherein the power output unit is selected from the group consisting of: a power outlet and a power cable.

5. The hub device capable of supplying power of claim 1, wherein the first electrical connection unit is selected from the group consisting of: an USB 2.0 electrical connector and an USB 3.0 electrical connector.

6. The hub device capable of supplying power of claim 1, wherein the second electrical connection unit is selected from the group consisting of: an USB 2.0 electrical connector, an USB 3.0 electrical connector, an USB 2.0 connection cable, and an USB 3.0 connection cable.

7. The hub device capable of supplying power of claim 1, wherein the power input unit, the Boost/Buck unit, the power output unit, the control unit, the plurality of first electrical connection units, and the second electrical connection unit are able to be implemented on a printed circuit board (PCB).

8. The hub device capable of supplying power of claim 7, further comprising a housing, being adapted to cover the printed circuit board and all units disposed on the printed circuit board.

9. The hub device capable of supplying power of claim 2, wherein the power input unit, the Boost/Buck unit, the power output unit, the control unit, the plurality of first electrical connection units, the second electrical connection unit, and the voltage adjusting unit are able to be implemented on a printed circuit board (PCB).

10. The hub device capable of supplying power of claim 9, further comprising a housing, being adapted to cover the printed circuit board and all units disposed on the printed circuit board.

11. A hub device capable of supplying power, comprising:
a power input unit, connecting to an external power source for receiving an input power;
a Boost/Buck unit, connecting to the power input unit so as to increase/reduce the voltage of the input power;
a power output unit, connecting to the Boost/Buck unit and outputting a rated output voltage;
a control unit, connecting to the Boost/Buck unit;
a plurality of first electrical connection units, connecting to the control unit, wherein after an electronic device is connected to one of the first electrical connection units, the control unit outputting a driving voltage to the first electrical connection unit for driving the first electrical connection unit;
a second electrical connection unit, connecting to the control unit and being used for connecting an external computer; and
a voltage adjusting unit, connecting to the Boost/Buck unit, wherein a set voltage value is defined through the voltage adjusting unit, and then the value of the rated output voltage outputted by the power output unit is the same to the set voltage value.

12. The hub device capable of supplying power of claim 11, wherein the power input unit is selected from the group consisting of: a power inlet and a power cable.

13. The hub device capable of supplying power of claim 11, wherein the power output unit is selected from the group consisting of: a power outlet and a power cable.

14. The hub device capable of supplying power of claim 11, wherein the first electrical connection unit is selected from the group consisting of: an USB 2.0 electrical connector and an USB 3.0 electrical connector.

15. The hub device capable of supplying power of claim 11, wherein the second electrical connection unit is selected from the group consisting of: an USB 2.0 electrical connector, an USB 3.0 electrical connector, an USB 2.0 connection cable, and an USB 3.0 connection cable.

16. The hub device capable of supplying power of claim 11, wherein the power input unit, the Boost/Buck unit, the power output unit, the control unit, the plurality of first electrical connection units, the second electrical connection unit, and the voltage adjusting unit can be implemented on a printed circuit board (PCB).

17. The hub device capable of supplying power of claim 16, further comprising a housing, being adapted to cover the printed circuit board and all units disposed on the printed circuit board.
